(19) United States
(12) Patent Application Publication
(10) Pub. No.: US 2007/0157213 A1
(43) Pub. Date: Jul. 5, 2007

(54) Method and system for providing message oriented middleware-dedicated instances

(76) Inventor: Michael Koegel, Roemerberg (DE)

Correspondence Address: SAP/BLAKELY, 12400 WILSHIRE BOULEVARD, SEVENTH FLOOR, LOS ANGELES, CA, 90025-1030, US

(21) Appl. No.: 11/322,796

(22) Filed: Dec. 30, 2005

(51) Int. Cl. G06F 9/46; G06F 9/44

(52) U.S. Cl. 719/315

(57) ABSTRACT

A method, apparatus, and system are provided for separate and dedicated instances for Message Oriented Middleware-related processes. In one embodiment, a standard instance having standard nodes having an application load and an MOM load is identified. The MOM load is separated from each of the standard nodes. The MOM load is run at MOM nodes.

### FIELD

Embodiments of the invention generally relate to the field of Message-Oriented Middleware (MOM) and more particularly, but not exclusively, to providing separate and dedicated instances for MOM-related processes.

### BACKGROUND

Traditional client-server systems employ a two-tiered architecture such as that illustrated in FIG. 1. Applications 102 executed on the client side 100 of the two-tiered architecture are comprised of a monolithic set of program code including a graphical user interface component, presentation logic, business logic and a network interface that enables client 100 to communicate over network 103 with one or more servers 101. A database 104 maintained on server 101 provides non-volatile storage for the data accessed and/or processed by application 102.

As is known in the art, the “business logic” component of the application represents the core of the application, for example, the rules governing the underlying business process (or other functionality) provided by the application. The “presentation logic” describes the specific manner in which the results of the business logic are formatted for display on the user interface. The “database” 104 includes data access logic used by the business logic to store and retrieve data.

The limitations of the two-tiered architecture illustrated in FIG. 1 become apparent when employed within a large enterprise. For example, installing and maintaining up-to-date client-side applications on a large number of different clients is a difficult task, even with the assistance of automated administration tools. Moreover, a tight coupling of business logic, presentation logic and the user interface logic makes the client-side code very brittle. Changing the client-side user interface of such applications is extremely hard without breaking the business logic, and vice versa. This problem is aggravated by the fact that, in a dynamic enterprise environment, the business logic may be changed frequently in response to changing business rules. Accordingly, the two-tiered architecture is an inefficient solution for enterprise systems.

In response to limitations associated with the two-tiered client-server architecture, a multi-tiered architecture has been developed, as illustrated in FIG. 2. In the multi-tiered system, presentation logic 221, business logic 222 and database 223 are logically separated from the user interface 220. These layers are moved off of client 225 to one or more dedicated servers on network 203. For example, presentation logic 221, business logic 222, and database 223 may each be maintained on separate servers, 226, 227 and 228, respectively.

This separation of logic components and the user interface provides a more flexible and scalable architecture compared to that provided by the two-tier model. For example, the separation ensures that all clients 225 share a single implementation of business logic 222. If business rules change, changing the current implementation of business logic 222 to a new version may not require updating any client-side program code. In addition, presentation logic 221 may be provided which generates code for a variety of different user interfaces 220, which may be standard browsers such as Internet Explorer® or Netscape Navigator®.

Although the multi-tiered system illustrated in FIG. 2 provides a more flexible architecture, it also results in significant additional complexity. For example, the distributed nature of applications and components within the multi-tiered system makes it more complicated for the applications and components to communicate with each other. A class of middleware known as MOM may be used to facilitate communication between applications and components.

An MOM refers to computer software that provides a message service between software components or applications. The message service provided by the MOM is often referred to as “loosely coupled” because a component sends a message to a destination and the recipient can retrieve the message from the destination. A message service typically includes a message provider and one or more clients. The message provider facilitates, for example, creating, sending, receiving, and reading messages. A client uses the message provider to, for example, send a message to a destination and another client may use the message provider to retrieve the message from the destination.

Although the message service facilitates communications between distributed software components and applications, it also reduces some of the flexibilities of the multi-tiered architecture. For example, the scalability of the multi-tiered architecture may be constrained by the capacity of a central message provider. Also, the central message provider requires a relatively brittle namespace scheme to ensure that messages are properly delivered. Furthermore, the malfunctioning applications on the same node as the MOM can negatively impact the MOM and other applications using the MOM through other nodes.

### SUMMARY

A method, apparatus, and system are provided for separate and dedicated instances for Message Oriented Middleware-related processes. In one embodiment, a standard instance having standard nodes having an application load and an MOM load is identified. The MOM load is separated from each of the standard nodes. The MOM load is run MOM nodes. In one embodiment, an instance includes an administrative unit that groups various components of a system that provides one or more services.

The above attributes may be implemented using a computer program, a method, a system, an apparatus, or any combination of computer programs, methods, or systems. These and other details of one or more embodiments of the invention are set forth in the accompanying drawings and in the description below

### BRIEF DESCRIPTION OF THE DRAWINGS

Embodiments are illustrated by way of example and not by way of limitation in the figures of the accompanying drawings in which like references indicate similar elements unless otherwise specified. It should be noted that references to “an” or “one” embodiment in this disclosure are not necessarily to the same embodiment, and such references mean at least one.

FIG. 1 illustrates a prior art two-tiered client-server architecture.

FIG. 2 illustrates a prior art multi-tiered client-server architecture.

FIG. 3 illustrates an embodiment of a Message Oriented Middleware provider.

FIG. 4 illustrates an embodiment of selected elements of an application server.

FIG. 5 illustrates an embodiment of a Message Oriented Middleware architecture.

FIG. 6 illustrates an embodiment of a Message Oriented Middleware architecture.

FIG. 7 illustrates an embodiment of a Message Oriented Middleware architecture.

FIG. 8 illustrates an embodiment of a Message Oriented Middleware architecture.

FIG. 9 illustrates an embodiment of a Message Oriented Middleware architecture.

FIG. 10 illustrates an embodiment of a Message Oriented Middleware architecture.

FIG. 11 illustrates an embodiment of a Message Oriented Middleware-dedicated instances and nodes-generating architecture.

FIG. 12 illustrates an embodiment of a process for a Message Oriented Middleware instance installation

FIG. 13 illustrates an embodiment of a process for generating Message Oriented Middleware-dedicated instances and nodes.

FIG. 14 illustrates a computing device implemented according to an embodiment of the invention.

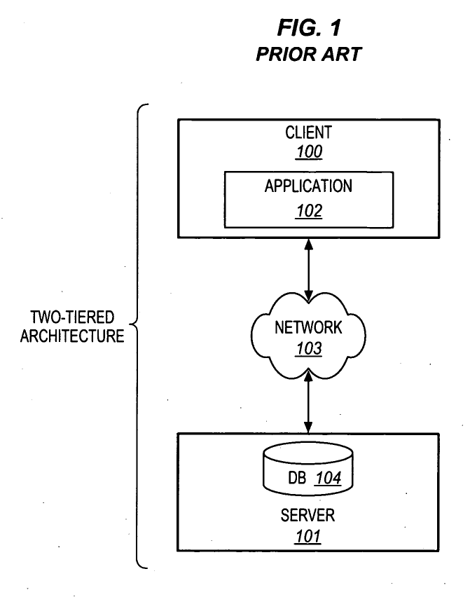

### DETAILED DESCRIPTION

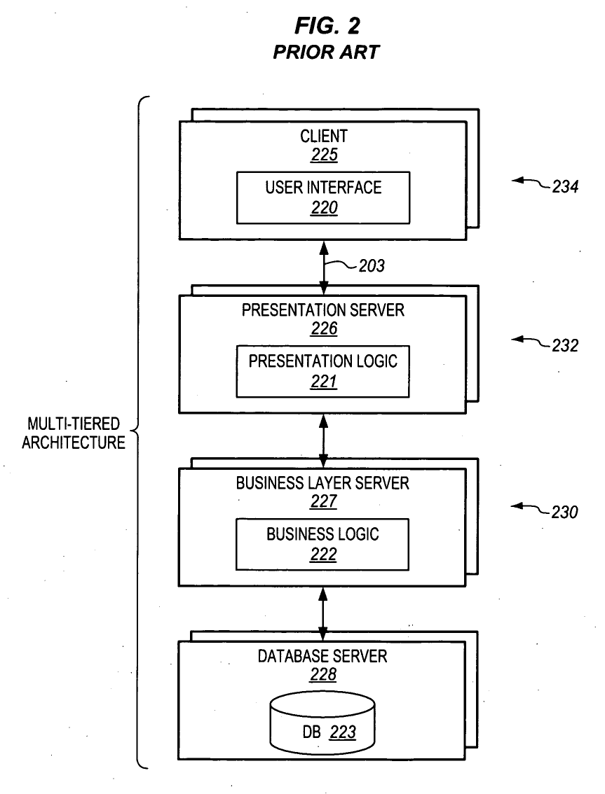

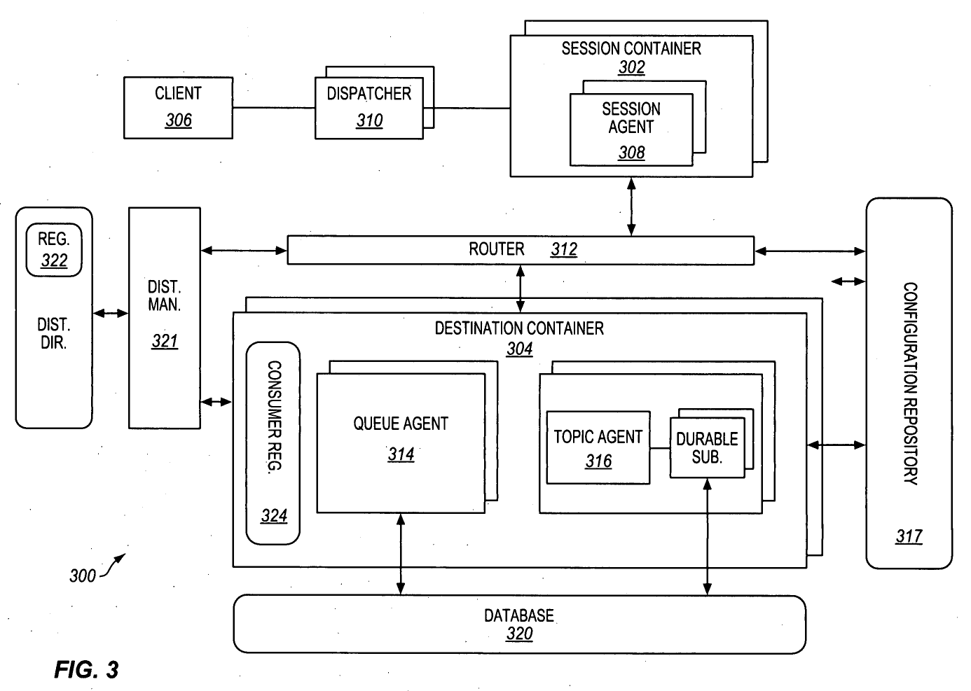

FIG. 3 illustrates an embodiment of a Message Oriented Middleware provider 300. As is further discussed below, MOM provider 300 may be integrated into a multi-tiered network (e.g., the multi-tiered network illustrated in FIG. 2). The multi-tiered network may be implemented using a variety of different application technologies at each of the layers of the multi-tier architecture, including those based on the Java 2 Enterprise Edition™ (J2EE) platform, the Microsoft NET platform, the Websphere platform developed by IBM Corporation, and/or the Advanced Business Application Programming (ABAP) platform developed by SAP AG.

In one embodiment, MOM provider 300 is implemented on an application server. The term “application server” broadly refers to a computing device that performs data processing. In a multi-tiered environment, such as the one illustrated in FIG. 2, application servers may provide the business logic for the distributed system. In an embodiment in which the business logic (e.g., business logic 222, shown in FIG. 2) exchanges information with a user interface (e.g., user interface 220, shown in FIG. 2) via the Internet, the application servers providing the business logic may be described as Web application servers.

MOM provider 300 may be separated into two main layers: session container 302 and destination container 304. Session container 302 is responsible for session and connection related tasks. The term “session” refers to an active connection between two elements of a distributed system (e.g., between two applications, between two components, between an application and a component, etc.). The term “connection” refers to a connection between an MOM client and the MOM provider.

When a client creates an MOM connection (e.g., via a directory lookup) the connection is bound to a session container (e.g., session container 302). All sessions created on the connection may also be bound to the session container. Session container 302 may manage the connections and sessions of multiple clients (e.g., client 306). Further, session container 302 includes a logical session agent 308 for each session it is managing. Session agent 308 may process (and/or preprocess) all requests for an MOM session using one or more logical handlers. The term “handler” refers to a software routine that performs a particular task. Examples of handlers provided by session agent 308 may include, and are not limited to, security management, logging, monitoring, transaction management, etc.

In operation, client 306 may send an MOM message to dispatcher 310 to be distributed to a destination. Session container 302 may accept the message and forward it to session agent 308. Session agent 308 may process the message and send it to router 312. Router 312 may be a logical component that transmits messages between session container 302 and destination container 304. Router 312 may include router code and/or may use the internal communication system of the application server.

Destination container 304 is responsible for executing the core messaging functions of storing messages (e.g., in volatile memory and/or persistently), maintaining the order of messages, and distributing the messages to the proper recipients. Destination container 304 includes all of the destination agents (e.g., queue agent 314 and topic agent 316) that are bound to the application server on which destination container 304 is implemented. The term “destination agent” refers to a software agent that is responsible for handling the messaging operations of a particular destination. In an embodiment, the destination agents are maintained in volatile memory as data structures for all destinations that are “active.” The term “active” may refer to a destination that has at least one consumer or producer attached.

MOM provider 300 may support one (or both) of the messaging schemes known as point-to-point and publish/subscribe messaging. In point-to-point messaging, each message is addressed to a specific queue. The term “queue” refers to a storage space either in memory or a persistent store (e.g., a database) for messages that are addressed to a particular client. A client establishes the queue to hold its messages. The queue may retain all messages sent to it until the messages are consumed or until they are expired.

In a publish/subscribe messaging scheme, a client addresses a message to a topic. The term “topic” refers to a storage space either in memory or a persistent store (e.g., a database) for messages that may be accessed by clients that subscribe to the topic. The topic may retain messages for as long as it takes to distribute the messages to all clients. Furthermore, queue agent 314 handles all messages for a particular queue (e.g., a queue in database 320 and/or in volatile memory). In one embodiment, queue agent 314 manages the order of messages within an associated queue. In such an embodiment, a separate queue agent 314 exists for each queue managed by destination container 304.

Topic agent 316 handles all messages sent to an associated topic. In such an embodiment, topic agent 316 includes logic to maintain the associated topic in volatile memory. In addition, topic agent 316 may include memory swapping logic to swap data between volatile memory and, for example, database 320. In an alternative embodiment, topic agent 316 includes logic to maintain the associated topic on database 320 (in addition to or instead of maintaining the topic in volatile memory).

Distribution manager 321 creates agents, as needed, for MOM provider 300 and its logical MOM server instances. For example, distribution manager 321 may create session agent 308, queue agent 314, and/or topic agent 316, as needed. In an alternative embodiment, destination agents (e.g., queue agent 314 and/or topic agent 316) are created by an appropriate AgentHandler for each destination that becomes active. In addition, session contexts may implement the functionality of session agents 308. A SessionHandler for each client session may create a session context and the session context may be stored in the corresponding connection context.

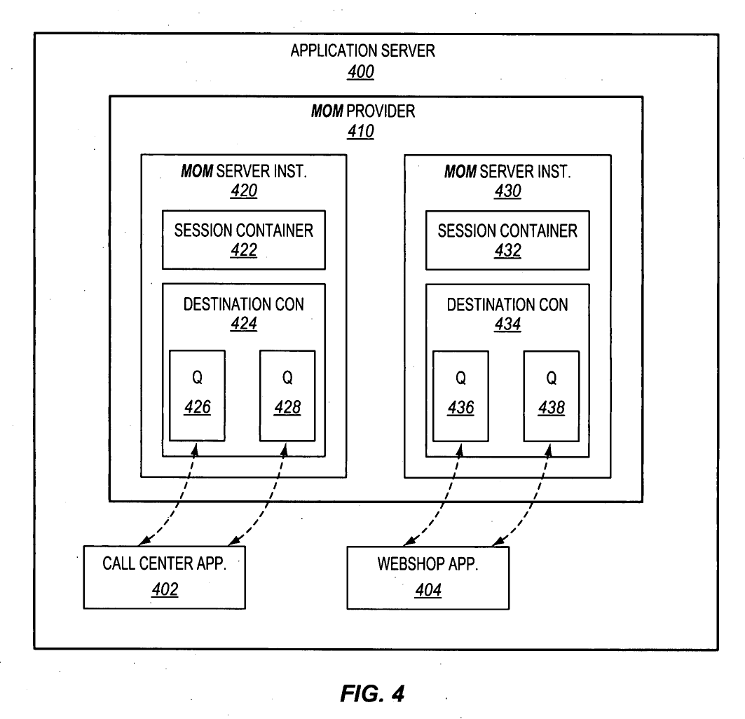

Router 312 and distribution manager 321 make use of one or more directories and repositories that store information for MOM provider 300. In an embodiment, destination registry 322 stores the physical location of the agents (e.g., queue agent 314 and/or topic agent 316) responsible for each destination. In an alternative embodiment (e.g., in which destination registry 322 is not implemented), destinations and related objects (e.g., queue agent 314 and/or topic agent 316) that belong to a given logical MOM server instance (e.g., logical MOM server instance 420, shown in FIG. 4) are hosted on the “parent” server node (e.g., application server 400, shown in FIG. 4). Consumer registry 324 maintains a list of consumers for each destination in destination container 304. Configuration repository 317 may store configuration information for MOM entities such as MOM server instances, queues, topics, durable subscriptions, and the like.

Database 320 may persistently store messages for queues and/or durable subscriptions. The term “durable subscription” refers to receiving messages at a topic for a client that is not active (e.g., not currently connected to the topic). In addition, database 320 may store data that is “swapped” in and out of volatile memory to conserve system resources. In an embodiment, database 320 includes a Database Management System (DBMS). The term “DBMS” refers to logic that provides overall organization of the data within a database. For example, a DBMS may retrieve the data from the database and/or ensure integrity of the data within the database. In an embodiment, the DBMS may be a “relational” DBMS (or simply, RDBMS).

FIG. 4 illustrates an embodiment of selected elements of an application server 400. Applications 402 and 404 are deployed to application server 400. Application 402 may be, for example, a call center application and application 404 may be a “Webshop” application. The term “Webshop” refers to buying and selling goods over the Internet.

MOM provider 410 provides a message service for applications and components executing on application server 400. MOM provider 410 includes logical MOM server instances 420 and 430. Logical MOM server instances 420 and 430 may be defined by separate configuration entities that specify, for example, identifiers for the logical instances, identifiers for the destinations, which destinations are assigned to which logical instance, and the like. For purposes of explanation, an embodiment of the invention having two logical MOM server instances is described. It is to be understood however, that only one server instance or more than two server instances may configured.

Initially, only one of applications 402 and 404 may be deployed on application server 400 and only one logical MOM server instance is configured. For example, call center application 402 may be deployed and logical MOM server instance 420 may be configured to provide a message service for call center application 402. In such an embodiment, the configuration options of MOM server instance 420 may be optimized for call center application 402. For example, session container 422 may be configured to provide one or more message sessions for application 402. Also, destination container 424 may be configured to provide queues 426 and 428 for application 402.

A potential challenge occurs, however, when Webshop application 404 is deployed to application server 400. It is possible that Webshop application 404 uses a queue that has the same name as one of the queues used by application 402. For example, call center application 402 may have two queues: QIncomingCalls 426 and QOrders 428. Similarly, Webshop application 404 may have the following two queues: NewUserRequest 436 and QOrders 438.

Logical MOM server instance 430 may be configured to separate the namespaces of the queues used by applications 402 and 404. For example, session container 432 may be configured to provide one or more message sessions for application 404. Destination container 434 may be configured to provide NewUserRequest queue 436 and QOrders queue 438. Since a separate logical MOM server instance is providing a message service for application 404, there is no conflict in the namespaces used by the queues of application 404 and the queues of application 402. In addition, it is easier to administer and optimize MOM server instance 430 because it providers an MOM service to a specific application.

In one embodiment, application server 400 is a J2EE application server. The term J2EE application server broadly refers to an application server that implements, at least in part, one of the J2EE specifications, for example, v1.3, published on Jul. 27, 2001 (hereinafter, the J2EE Standard). Examples of a J2EE application server may include, for example, the Web Application Server (Web AS) provided by SAP AG and the Websphere application server by IBM Corporation. In an alternative embodiment, application server 400 is implemented according to a different platform, for example, the Microsoft.NET platform.

In one embodiment, logical MOM server instances 420 and 430 may include Java Messaging Service (JMS)-based MOM server instances. A JMS-based server instance may broadly refer to an MOM server instance that implements, at least in part, the JMS application program interface (API). In an alternative embodiment, logical MOM server instances 420 and 430 may be based on a different messaging API.

A logical MOM server instance (e.g., logical MOM server instance 420) may be specified by a configuration entity having one or more items of configuration information. The configuration information established for each MOM server instance may be used to distribute and process messages (e.g., the configuration information may be used to identify a “name” of a server instance).

It is to be noted that JMS, JMS-based instances, JMS providers, JMS nodes, and other JMS-related components, modules, and functionalities are described in the following figures and mentioned throughout this document merely as an example and for brevity and clarity. Embodiments of the invention are not exclusive or limited to only JMS and may include and/or related to other MOM-related features, components, and functionalities. As described with reference to FIG. 4, in one embodiment, logical MOM server instances may include JMS-based MOM server instances. A JMS-based server instance may broadly refer to an MOM server instance that implements, at least in part, the JMS API. In an alternative embodiment, logical MOM server instances may be based on a different messaging API. Furthermore, any MOM architecture/structure or JMS architecture/structure described throughout this document may reside at an application server (e.g., application server 400), such as a J2EE application server which may include, for example, the Web Application Server (Web AS) provided by SAP AG, the Websphere application server by IBM Corporation, etc. In an alternative embodiment, application server 400 is implemented according to a different platform, such as, the Microsoft NET platform.

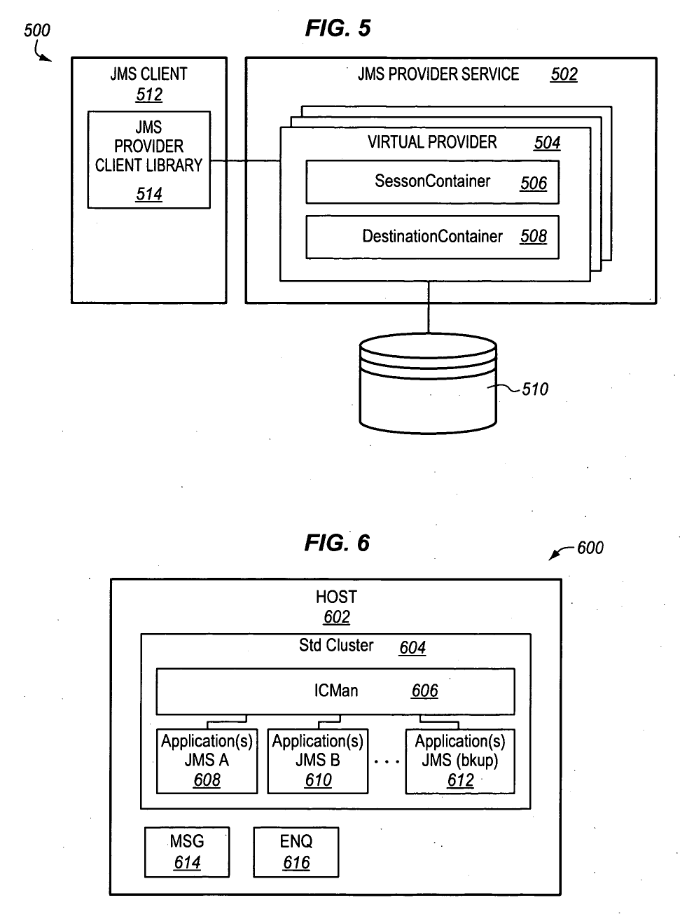

FIG. 5 illustrates an embodiment of a Message Oriented Middleware architecture 500. MOM architecture 500 includes an embodiment of an MOM provider (e.g., JMS provider) and MOM provider-related components (e.g., JMS provider-related components). In the illustrated embodiment, MOM architecture 500 includes JMS provider service 502 that runs on each node or virtual machine (VM) (e.g. Java VM (JVM)) in a cluster of nodes to provide the main functionality for applications using JMS. Further, JMS provider service 502 can divide into several components and sub-components. JMS provider service 502 is coupled to and in communication with JMS client 512. JMS client 512 includes JMS provider client library 514 that is used by each application or service that is to use JMS provider service 502 and JMS virtual provider 504. JMS provider client library 514 may also implement various interfaces (e.g., javax.jms), handle the communication with JMS provider service 502, and optimize the client performance by buffering messages on the client side. Provider service 502 is coupled to and in communication with database 510.

JMS virtual provider 504 includes a JMS provider with a namespace. Each virtual provider 504 may include a set of JMS administered objects. Such administered objects from different virtual providers 504 may not be mixed or mingled, such as a “ConnectionFactory” from virtual provider A may not be used to create a “Producer for a Queue” that is hosted at virtual provider B. Applications that communicate with each other use the JMS that uses the same virtual provider 504. Further, the JMS load generated by one application can be separated from other applications by giving that application a dedicated virtual provider 504 such that as a single virtual provider 504 is bound to a single corresponding JVM. JMS virtual provider 504 further provides various components (e.g., JMS server frame, JMS server container, etc.) that are used to implement the needed interfaces to allow JMS virtual provider 504 to run as a service at or inside an engine, such as the J2EE engine. The functionality of such interfaces includes lifecycle for the service, cluster awareness, eventing, and general infrastructure access. Further, these interfaces serve as communication endpoints for JMS provider client library 514.

JMS virtual provider 504 further provides containers, such as session container 506 and destination container 508. Session container 506 manages connections, sessions, producers, and consumers created by clients. Destination container 508 may be part of a server to hold and manage the data structures that contain JMS messages. Further, destination container 508 contains message repository, work lists, consumer view, and persistency service. A message repository includes central part of the queuing engine and is responsible for providing JMS messages in the correct order. The message repository also maintains an order-aware message cache, but also accesses the database 510. Further, the message repository includes a message directory and a master queue.

A message directory may contain hash maps and/or persistent and non-persistent messages, and message request objects that are being processed and/or stored at master queue. The message directory further contains the message request objects that are stored in the master queue as well as those currently being processed. A message directory serves the following purposes: (1) providing access to message objects; and (2) avoiding duplicate creation of objects for the same JMS messages; for example, whenever a message is read from database 510, a message directory is first checked for an already existing related message object. The master queue represents a part of the message queue in the memory. Further, the master queue contains available messages, without any gaps, between the first message and the last message. When a new message arrives that has a higher priority than the last message in the master queue, it is inserted into the appropriate position immediately.

A work list represents the part of a message queue that is being currently processed by a consumer. It is not to be confused with the master queue. The master queue is a message cache which respects the message order. The work list, on the other hand, uses this cache, but it may also get messages from the database. Since topic consumers receive and process the messages independently of each other, there is a separate work list object assigned to each consumer. A work list contains an array that can be considered a “cursor” indicating the current position within the message queue. It can point to a message within the master queue as well as to any message outside. Each work list has its own priority queue, which is used to buffer messages that need to be delivered to the consumer but are not contained in the master queue. The objects within this queue are message handles and are relatively small objects which contain a reference to the actual message. The message handles are taken from a pool of handles when required and are later, returned. There is, however, no distinction between work lists that are with or without a message selector.

For each consumer, there is a consumer view object representing a subset of the message queue specific to that consumer. It is called by a topic agent and interacts in turn with its related work list. A persistency service is regarded as the central point for persisting JMS messages to a relational database and retrieving them again.

FIG. 6 illustrates an embodiment of a Message Oriented Middleware architecture 600. MOM architecture 600 includes a JMS structure that includes host 602 having multiple nodes (e.g., VMs) 608-612. Each occupied node 608-610 includes an MOM virtual provider (e.g., JMS virtual provider). In one embodiment, a set of JMS resources that are needed to handle the sum of all JMS clients can be divided into a number of subsets. Each subset is handled by a separate JMS virtual provider associated with a node 608-610. In other words, each of the multiple virtual providers runs on a separate corresponding node or VM 608-610 in cluster 604, leveraging the available system resource more fully and properly than having multiple JMS virtual providers running on a single node or VM could. Furthermore, if there are more nodes available (e.g., node 612) than the number of available virtual providers, such remaining nodes without an assigned virtual provider are set up to act as backup nodes, such as node 612, ready to take over the duties of those virtual providers whose corresponding nodes 608-610 should fail. In the illustrated embodiment, each node 608-612 in cluster 604 is uniformly assigned to run the application load as well as the JMS load. Host 602 further includes messaging server 614 and enquiring (ENQ) server 616.

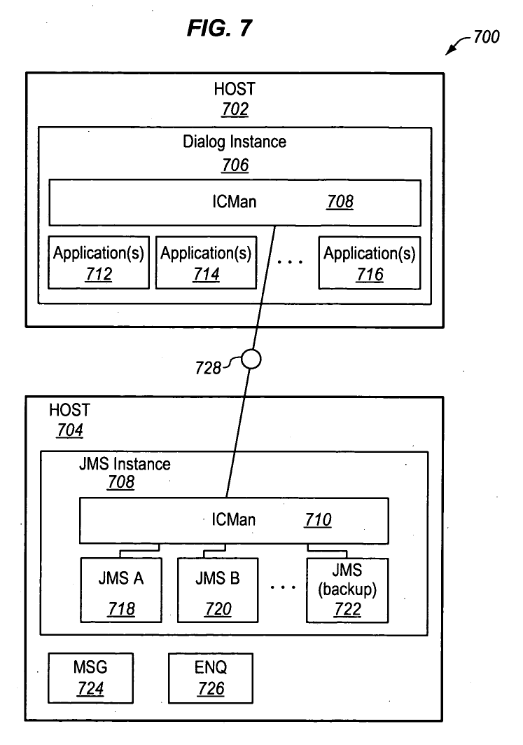

FIG. 7 illustrates an embodiment of a Message Oriented Middleware architecture 700. MOM architecture 700 includes a JMS architecture/structure. In one embodiment, using an installation option, the JMS load is separated from the application load by providing a separate set of nodes (e.g., JVM) 718-722 that are dedicated to running the JMS load. In one embodiment, JMS node 722 serves as a backup node that is made available so that in the event that the failure of an already operating JMS node 718-720 is detected, the orphan virtual provider from that corresponding failed node is immediately and seamlessly reclaimed by backup JMS node 722. For example, using this backup node technique, the orphan virtual provider from a failed node may be reclaimed within seconds. In the absence of a backup node, such as JMA backup node 722, the downtime of the orphan or impacted virtual provider is typically as long as it takes to restart a node (e.g., several minutes) which is inefficient and wasteful. These JMS nodes 718-722 at JMS instance 708 are separate from application nodes 712-716 that handle or run the application load at default or standard or dialog instance 706. In one embodiment, an installation option is used to provide an installation instance that includes JMS instance 708 where a number of nodes 718-722 that are dedicated to JMS are hosted. The installation option provides for various modules and/or components to facilitate (1) the installation of JMS instance 708, (2) recognize the available standard nodes or VMs at dialog instance 706 running the application and JMS loads, (3) provide JMS instance 708 where JMS nodes 718-722 are hosted, and (4) extract the JMS load from standard nodes leaving the standard nodes as application nodes 712-716 running only the application load, while JMS nodes 718-722 are used to the separated JMS load. In one embodiment, an instance (e.g., JMS instance, dialog instance 706, etc.) includes an administrative unit that groups various components of a system (e.g., SAP system) that provides one or more services. These services are started, stopped, and monitored at the same time. The components belonging to an instance are provided with parameters using a common instance profile. For example, a single SAP system may contain a single instance in which the required SAP services are provided.

In one embodiment, JMS nodes 718-722 do not run applications and are dedicated to JMS. Having JMS nodes 718-722 that are dedicated to the JMS service, the resources available to such nodes 718-722 can be fully leveraged by the JMS service. For example, a much bigger part of the memory can be used for caching messages than could be used without JMS-dedicated nodes 718-722. In one embodiment, host 704 further includes messaging server 724, ENQ server 726 and database that are also used by host 702 coupled to host 704. These messaging and ENQ servers 724-726 and the database may reside at a separate host or server, i.e., at host or server other than hosts 702-704. In one embodiment, host 702 communicates with host 704 using a protocol 728, such as the one transferred by SAP P4 Remote Method Invocation (RMI) implementation.

Each virtual provider is assigned a JMS node 718-722. Each JMS node 718-722 may run the assigned virtual provider to run the JMS load. Application nodes 712-716 run applications at dialog instance 706. In one embodiment, if the JMS nodes exceed the number of JMS virtual providers available for running, these remaining JMS nodes are regarded as backup nodes 722 without having being assigned a virtual provider. Backup nodes 722 are used to seamlessly and immediately (e.g., within seconds) take over the operation of those virtual providers whose corresponding JMS nodes 718-720 have failed. For example, in case of the failure of JMS node 718, JMS backup node 722 immediately takes over the running of the virtual provider corresponding to JMS node 718 that has failed. Each JMS virtual node having run on separate JMS nodes 718-722 and having nodes 718-722 dedicated to JMS allows for leveraging of the available system resources more fully, properly, and efficiently than having nodes that run both JMS and applications or having a single JMS node run all the JMS virtual providers. In other words, in the illustrated embodiment, various individual JMS nodes 718-722 are provided to individually run each of the JMS virtual providers, resulting in an even greater leveraging of available system resources.

For example, JMS nodes 718-722 can provide the usage of more than one JVM that is used to reach the necessary throughput which may be needed when a particular or unconventional JVM may be used that does not scale as well into high numbers of parallel threads than traditional JVMs. Furthermore, the intrinsic nature of JMS destinations may require strict message ordering which in turn may not allow the distribution of such destinations without global access synchronization to not compromise the message order. Also, having separate and multiple JMS-dedicated nodes 718-722 helps prevent a global synchronization that would otherwise impose a very high performance overhead which requires the number of destinations being handled by a single JVM or node. Furthermore, employing separate and multiple JMS-dedicated nodes 718-722 automatically provides the needed QoS to keep separate the application load from the rest of the JMS load to allow the system resources for individual tuning and to avoid the demanding JMS usage scenarios that the combined usage of running the application and JMS loads at a single node requires. Also, JMS nodes 718-722 help separate a JMS load from an application load to prevent the stopping of ongoing JMS sessions that are often dropped which impacts user sessions hosted on other nodes when a node exceeds a threshold, such as in terms of lifetime, memory consumption, etc. Separate JMS nodes 718-722 provide a stability of performance, lower computer processing unit (CPU) consumption, and additional resources for memory cache, shortcuts to database, etc.

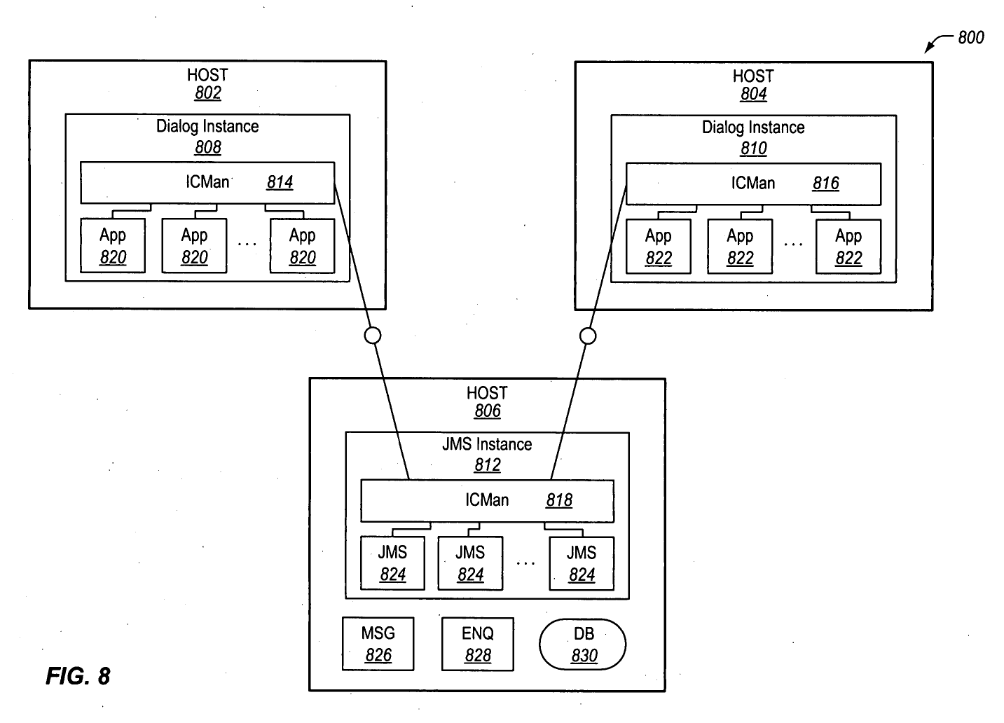

FIG. 8 illustrates an embodiment of a Message Oriented Middleware architecture 800. MOM architecture 800 includes a JMS structure that includes multiple MOM hosts 802-804 having nodes (e.g., VM) 820-822 running applications. In one embodiment, the JMS load is separated from the application load being handled by standard nodes 820-822 at dialog instances 808-810 residing at hosts 802-804. This JMS load is handled separately by various JMS-dedicated nodes 824 at JMS-dedicated JMS instance 812 at host 806. As described above, each node 824 runs a JMS virtual provider to run the JMS load that is separated from the application load being handled at nodes 820-822. In one embodiment, JMS running at one or more nodes 824 at JMS instance 812 may be installed at a high availability hardware functioning in a high availability mode. Furthermore, host 806 that is in communication with hosts 802-804 further includes messaging and ENQ servers 826-828 as well as database 830; however, these servers 826-828 and database 830 may be installed at another server host, such as at one or more hosts other than hosts 802-806. Messaging server 826, ENQ server 828, and database 830 may be needed for each cluster (e.g., a combination or sum of instances 808-812) and not for each host 802-806 and thus, a single set of servers 826-828 and database 830 may be used and can be located at any of hosts 802-806 or at an entirely different host.

In one embodiment, JMS instance 812 starts with heavily reduced services as JMS instance 812 is independent of the application load. In one embodiment, a JMS template is extracted from an already created/present standard template and using the JMS template, the JMS load is separated from the application load to be processed at JMS-dedicated nodes 824. A JMS provider refers to a service inside a web application server Java that is used to implement the JMS specification, while JMS refers to Java Messaging Service that provides the specification for asynchronous messaging using the Java language. Each node 820-824 refers to a VM or JVM, while each instance 808-812 refers to a homogenous set of server nodes 820-824 running on physical machines or computer systems. A cluster is a set of one or more such instances 808-812 that is spanned over several physical machines. Each physical machine may run one or more instances. JMS instance 812 may include a separate installation option that allows the separation of JMS nodes 824 running the JMS provider from standard nodes 820-822 running other services and applications.

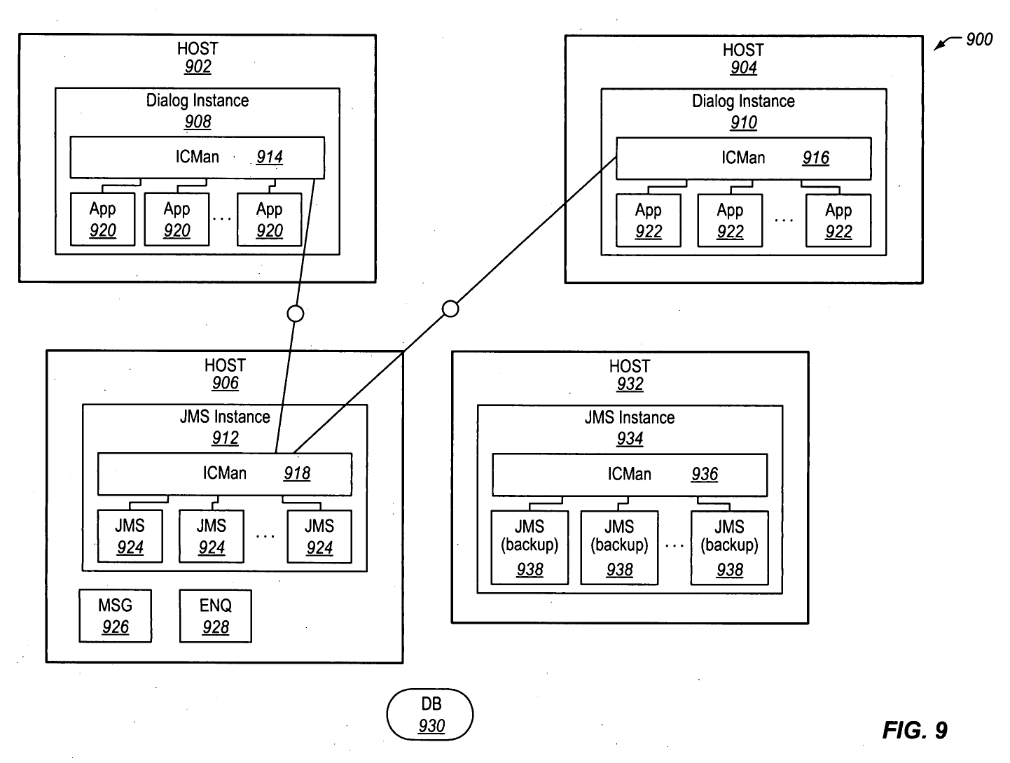

FIG. 9 illustrates an embodiment of a Message Oriented Middleware architecture 900. For brevity, components and functions described above, particularly with reference to FIGS. 7-8, are not described here. MOM architecture 900 includes a JMS architecture or structure. The illustrated embodiment provides multiple and separate hosts 906 and 932 having JMS instance 912 and JMS instance 934 to host JMS-dedicated nodes 924 and JMS-dedicated backup nodes 938, respectively. In one embodiment, backup nodes 938 are to provide backup to nodes 924 in case one or more of nodes 924 fail. Backup nodes 938 are not yet assigned a virtual provider as they serve as backup to JMS nodes 924 and are used to immediately take over orphan virtual providers from the failing or failed nodes 924 without software failover. In one embodiment, as illustrated, backup JMS nodes 938 at JMS instance 934 are provided at host 932 that is separate from host 906 where other JMS nodes 924 at JMS instance 912 reside. Furthermore, in the illustrated embodiment, database 930 is remotely located. In one embodiment, JMS may still be present at standard nodes 920-922; however, the JMS at standard nodes 920-922 is provided in its minimal mode primarily for administration purposes.

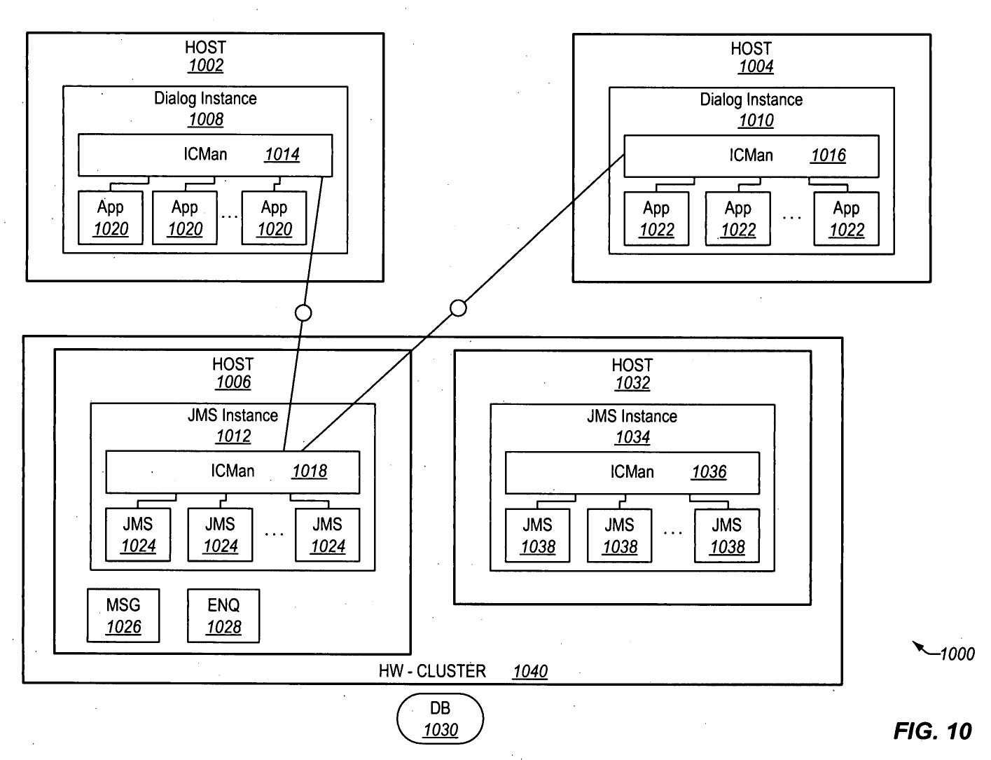

FIG. 10 illustrates an embodiment of a Message Oriented Middleware architecture 1000. For brevity, components and functions described above, particularly with reference to FIGS. 7-9, are not described here. MOM architecture 1000 includes a JMS architecture or structure. In one embodiment, hosts 1006, 1032 having JMS instances 1012, 1034 further having JMS-dedicated nodes 1024, 1038, respectively, are connected and in communication with each other in a common hardware cluster 940, further minimizing or even eliminating any potential system downtime. JMS instance 1012, 1034 and JMS nodes 1024, 1038 may communicate at the operating systems level within hardware cluster 1040.

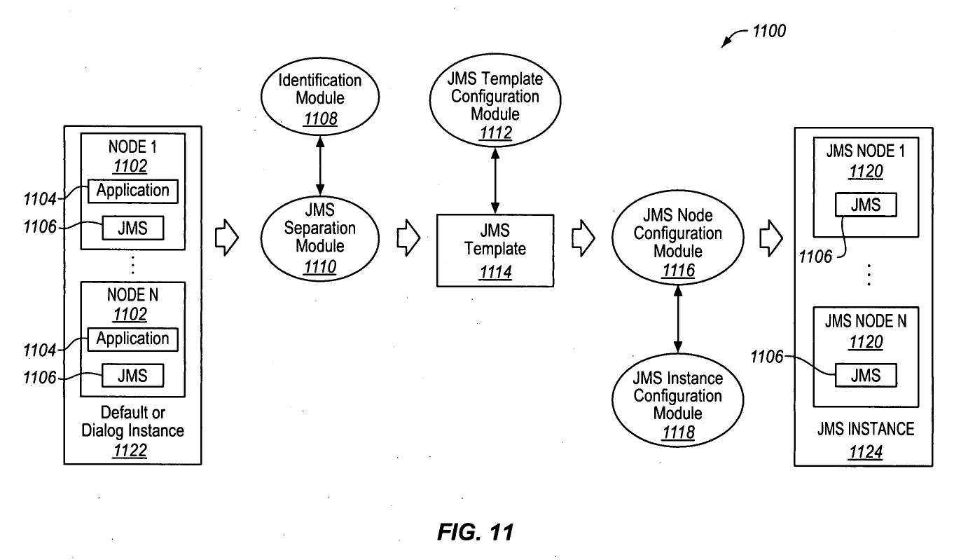

FIG. 11 illustrates an embodiment of a Message Oriented Middleware-dedicated instance and node-generating architecture 1100. A MOM-dedicated instance and MOM-dedicate node includes a JMS-dedicated instance 1124 and JMS-node 1120, respectively. In one embodiment, identification module 1108 identifies standard nodes 1-N 1102 at default or dialog or standard instance 1122. Nodes 1-N 1102 may be created using a standard node template such that nodes 1-N 1102 are capable of handling both application 1104 and JMS 1106 at default instance 1122. Identification module 1108 that identifies and detects nodes 1-N 1102 then provides the relevant information to JMS separation module 1110. JMS separation module 1110 is used to separate JMS 1106 from application 1104 from nodes 1-N 1102 so that JMS 1106 may be processed separately at various dedicated JMS nodes 1-N 1120.

In one embodiment, JMS configuration template 1114 is created using JMS template configuration module 1112. JMS node configuration module 1116 incorporates JMS-relevant information (that is separated and extracted using JMS separation module 1110) into JMS template 1114 (that is created using JMS template configuration module 1112). JMS node configuration module 1116 then creates JMS nodes 1-N 1120 that are dedicated to running JMS 1106. JMS instance configuration module 1118 works in communication with JMS node configuration module 1116 to provide JMS instance 1124 to host JMS nodes 1-N 1120 to run and process JMS 1106. Once JMS nodes 1-N 1120 are created, assigned virtual providers, and have started running JMS 1106, standard nodes 1-N 1102 are left to run application 1104 and other system projects. In one embodiment, some JMS 1106 may be left at nodes 1-N 1102 for administrative uses.

In one embodiment, administrative tools are provided to access configuration services to inspect and modify configuration information. These administrative tools may include a graphical user interface (GUI) and/or a shell console (e.g., command line driven interface). An administrative tool may include a Web-based administrative tool. An administrative tool may also provide a GUI, which may be a swing-based GUI. A Swing-based GUI refers to a GUI that is based on the Swing API provided by, for example, the Java 2 Platform, Standard Edition (J2SE), Specification, 1.4.2, Nov. 20, 2003.

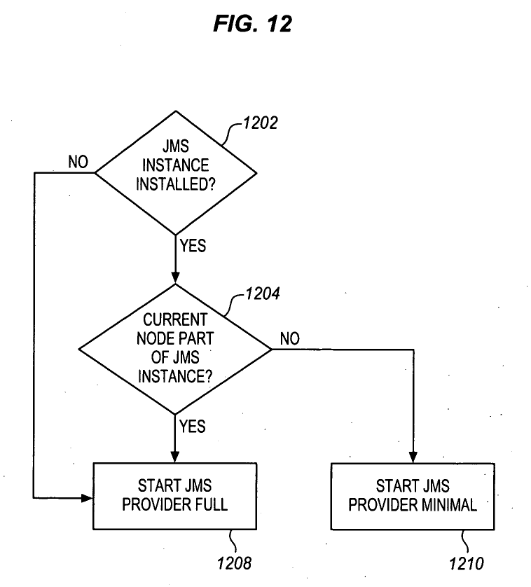

FIG. 12 illustrates an embodiment of a process for a Message Oriented Middleware instance installation. An example of an MOM instance includes a JMS instance. In one embodiment, a JMS instance is installed just as a standard dialog instance. However, a JMS instance is different from a standard dialog instance or a J2EE instance in that the JMS instance uses a special JMS configuration template to start and run JMS provider service and various services required by it, such as running a JMS virtual provider at a JMS node (e.g., JVM). Furthermore, a JMS configuration template may override the settings for the share of heap available to the JMS node that is used for JMS cache with a much bigger value than the value available that is typically in a standard dialog instance.

To determine whether a JMS virtual provider is to be fully started on a current JMS node, first, a determination is made as to whether a JMS instance is installed at decision block 1202. If not, the JMS provider service is fully started at processing block 1208. The full start of a JMS provider may include an installation of a JMS instance. In one embodiment, the fully starting of the JMS provider service includes a JMS node to run a JMS virtual provider by seeking an available JMS virtual provider from all virtual providers available in configuration. Seeking the available JMS virtual provider may also include a JMS node acquiring a lock for the JMS virtual provider from ENQ server. If the lock is not acquired, the process continues with the JMS node continuing to seek another available node until there are no more virtual providers, in which case the JMS node is regarded as a backup node. If, however, a JMS virtual provider is available and the lock for it is successfully acquired, the JMS node hosts and runs the JMS virtual provider. In one embodiment, the selection of an available JMS virtual provider is performed by a JMS node using a virtual provider selection module (selection module). The selection module may also include a lock acquiring module which is to facilitate the acquiring of the lock for the virtual provider that the JMS node is seeking. In one embodiment, the lock acquiring module may be separate from, but in communication with, the selection module. Also, in one embodiment, a module, such as the selection module, may be used to classify the JMS node that fails to acquire a JMS virtual provider as a backup node.

If a JMS instance is installed, at decision block 1204, a decision is made as to whether the current node is part of the JMS instance. If the current node is part of the JMS instance, the JMS provider service is fully started at processing block 1208. If the current node is not part of the JMS instance, the JMS provider service is started with minimal use at processing block 1210.

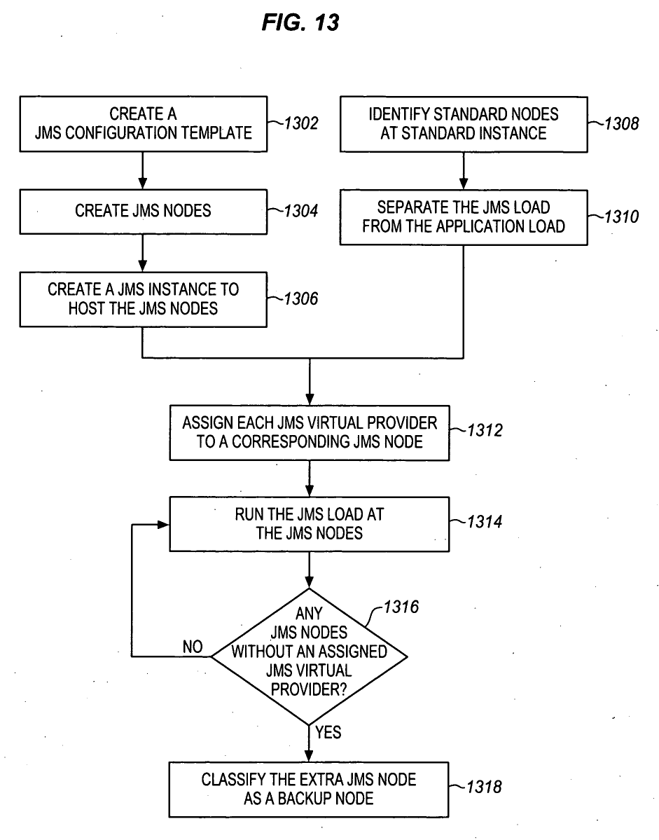

FIG. 13 illustrates an embodiment of a process for generating Message Oriented Middleware-dedicated instances and nodes. As described above, an example of MOM-dedicated instances and nodes includes JMS-dedicated instances and nodes, respectively. In one embodiment, first, one or more JMS configuration templates are created at processing block 1302. Using the JMS configuration templates, JMS-dedicated nodes may be created to run JMS at processing block 1304. Then, one or more JMS instances are created to host the JMS nodes at processing block 1306. Meanwhile, the standard nodes running applications, JMS and other system operations are identified at processing block 1308. These standard nodes reside at standard instances. Once the standard nodes are identified, the JMS load is separated from the application load at the standard nodes so that the JMS load can be processed at JMS-dedicated nodes at processing block 1310.

At processing block 1312, each JMS node is assigned a JMS virtual provider that is provided to run a JMS load. The JMS nodes run the JMS load at processing block 1314. At decision block 1316, a determination is made as to whether there are additional JMS-dedicated nodes, such as, whether there are more JMS nodes than there are virtual providers. If there are no such JMS-dedicated nodes, JMS running continues at processing block 1314. If there are such JMS-dedicated nodes, they are classified or regarded as backup JMS-dedicated nodes so that they can be used to continue the operation without interruptions when one or more already operating JMS-dedicated nodes fail at processing block 1318. The process continues with the running of the JMS load at processing block 1314.

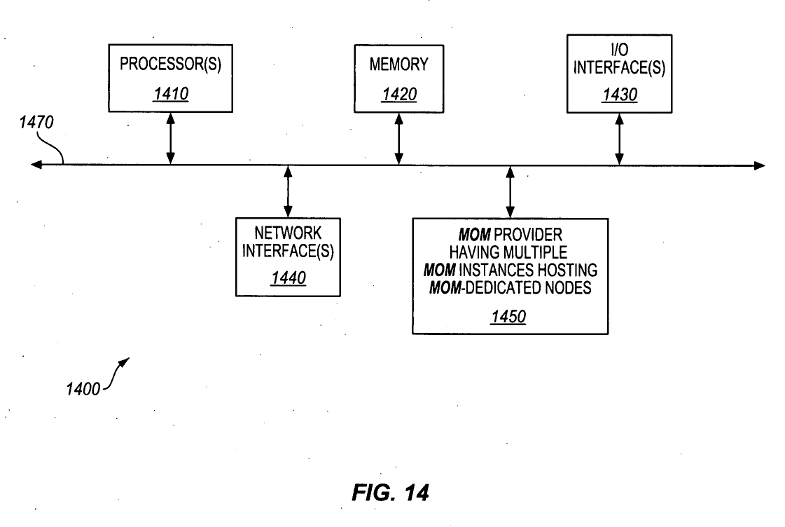

FIG. 14 illustrates a computing device 1400 implemented according to one embodiment of the invention. Computing device 1400 may include: processor(s) 1410, memory 1420, one or more Input/Output interfaces 1430, network interface(s) 1440, and MOM/MOM provider 1450 having multiple and separate JMS instances that host JMS nodes that are dedicated to running JMS and not applications or other system operations. The illustrated elements may be connected together through system interconnection 1470. Processor(s) 1410 may include a microprocessor, microcontroller, field programmable gate array (FPGA), application specific integrated circuit (ASIC), central processing unit (CPU), programmable logic device (PLD), and similar devices that access instructions from system storage (e.g., memory 1420), decode them, and execute those instructions by performing arithmetic and logical operations.

The MOM provider having multiple server instances 1450 enables computing device 1400 to provide a scalable MOM provider for an enterprise network. MOM provider having multiple server instances 1450 may be executable content, control logic (e.g., ASIC, PLD, FPGA, etc.), firmware, or some combination thereof, in an embodiment of the invention. In embodiments of the invention in which MOM provider having multiple server instances 1450 is executable content, it may be stored in memory 1420 and executed by processor(s) 1410.

Memory 1420 may encompass a wide variety of memory devices including ROM, erasable programmable read-only memory (EPROM), electrically erasable programmable read-only memory (EEPROM), RAM, non-volatile random access memory (NVRAM), cache memory, flash memory, and other memory devices. Memory 1420 may also include one or more hard disks, floppy disks, ZIP disks, compact disks (e.g., CD-ROM), digital versatile/video disks (DVD), magnetic random access memory (MRAM) devices, and other system-readable media that store instructions and/or data. Memory 1420 may store program modules such as routines, programs, objects, images, data structures, program data, and other program modules that perform particular tasks or implement particular abstract data types that facilitate system use.

One or more I/O interfaces 1430 may include a hard disk drive interface, a magnetic disk drive interface, an optical drive interface, a parallel port, serial controller or super I/O controller, serial port, universal serial bus (USB) port, a display device interface (e.g., video adapter), a network interface card (NIC), a sound card, modem, and the like. System interconnection 1470 permits communication between the various elements of computing device 1400. System interconnection 1470 may include a wide variety of signal lines including one or more of a memory bus, peripheral bus, local bus, host bus, bridge, optical, electrical, acoustical, and other propagated signal lines.

One or more modules may include hardware, software, and/or a combination of these. In a case where a module includes software, the software data, instructions, and/or configuration may be provided via an article of manufacture by a machine/electronic device/hardware. An article of manufacture may include a machine accessible/readable medium having content to provide instructions, data, etc. The content may result in an electronic device, for example, a filer, a disk, or a disk controller as described herein, performing various operations or executions described. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. The machine accessible medium may further include an electronic device having code loaded on a storage that may be executed when the electronic device is in operation. Thus, delivering an electronic device with such code may be understood as providing the article of manufacture with such content described above. Furthermore, storing code on a database or other memory location and offering the code for download over a communication medium via a propagated signal may be understood as providing the article of manufacture with such content described above.

The architectures and methodologies discussed herein may be implemented with various types of computing systems such as an application server that includes a J2EE server that supports EJB components and EJB containers (at the business layer) and/or Servlets and JSP (at the presentation layer). Of course, other embodiments may be implemented in the context of various different software platforms including, by way of example, Microsoft® NET, Windows®/NT, Microsoft Transaction Server (MTS), the ABAP platforms developed by SAP AG and comparable platforms.

As used herein, references to one or more “embodiments” are understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

In the foregoing description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the present invention. It will be appreciated, however, to one skilled in the art that the embodiments of the present invention may be practiced without such specific details, based on the disclosure provided. In other cases, control structures, gate level circuits and full software instruction sequences have not been shown in detail in order not to obscure the invention. Those of ordinary skill in the art, with the included descriptions, will be able to implement appropriate functionality without undue experimentation.

Throughout the description, for the purposes of explanation, numerous specific details are set forth in order to provide a thorough understanding of the embodiments of the present invention. It will be apparent, however, to one skilled in the art that the present invention may be practiced without some of these specific details. In other cases, well-known structures and devices are shown in block diagram form to avoid obscuring the underlying principles of the present invention.

In addition to what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method, comprising:
identifying a standard instance having a plurality of standard nodes having an application load and a Message Oriented Middleware (MOM) load;
separating the MOM load from each of the plurality of standard nodes; and
running the MOM load at a plurality of MOM nodes.

2. The method of claim 1, wherein the MOM load comprises a Java Messaging Service (JMS) load, the JMS load including JMS-based services.

3. The method of claim 1, wherein each of the plurality of MOM node comprises a JMS node.

4. The method of claim 1, further comprising creating the plurality of MOM nodes, wherein each of the plurality of MOM nodes is dedicated to running the MOM load.

5. The method of claim 1, further comprising running the MOM load at the plurality of MOM nodes by running a MOM virtual provider at each of the plurality of MOM nodes.

6. The method of claim 5, further comprising assigning each of a plurality of MOM virtual providers to each of the plurality of MOM nodes.

7. The method of claim 6, further comprising classifying each of the plurality of MOM nodes that is not assigned a MOM virtual provider as a backup MOM node.

8. The method of claim 1, further comprising running the application load at the plurality of standard nodes at the standard instance, the plurality of standard nodes including a plurality of application nodes.

9. The method of claim 1, further comprising creating a MOM instance to host the plurality of MOM nodes.

10. The method of claim 1, wherein each of the plurality of MOM nodes comprise a virtual machine (VM), the virtual machine including a Java virtual machine (JVM).

11. An apparatus, comprising:
means for identifying a standard instance having a plurality of standard nodes having an application load and a Message Oriented Middleware (MOM) load;
means for separating the MOM load from each of the plurality of standard nodes; and
means for running the MOM load at a plurality of MOM nodes.

12. The apparatus of claim 11, wherein the MOM load comprises a Java Messaging Service (JMS) load, the JMS load including JMS-based services.

13. The apparatus of claim 11, wherein each of the plurality of MOM node comprises a JMS node.

14. The apparatus of claim 11, further comprising means for creating the plurality of MOM nodes, wherein each of the plurality of MOM nodes is dedicated to running the MOM load

15. A system, comprising:
an application server to serve an application to a client, the application server having a Message Oriented Middleware (MOM) provider to provide a message service to the application server, the MOM provider including
an identification module to identify a standard instance having a plurality of standard nodes having an application load and a Message Oriented Middleware (MOM) load;
a separation module to separate the MOM load from each of the plurality of standard nodes; and
a plurality of MOM nodes to run the MOM load.

16. The system of claim 15, wherein the MOM load comprises a Java Messaging Service (JMS) load, the JMS load including JMS-based services.

17. The system of claim 15, wherein the application server comprises a Java 2 Enterprise Edition (J2EE)-based application server.

18. An article of manufacture comprising a machine-accessible medium having instructions which when executed cause a machine to:
identify a standard instance having a plurality of standard nodes having an application load and a Message Oriented Middleware (MOM) load;
separate the MOM load from each of the plurality of standard nodes; and
run the MOM load at a plurality of MOM nodes

19. The article of manufacture of claim 18, wherein the instructions which when executed further cause the machine to create the plurality of MOM nodes, wherein each of the plurality of MOM nodes is dedicated to running the MOM load.

20. The article of manufacture of claim 18, wherein the instructions which when executed further cause the machine to run the MOM load at the plurality of MOM nodes by running a MOM virtual provider at each of the plurality of MOM nodes.
